(19) United States
(12) Patent Application Publication
(10) Pub. No.: US 2004/0074030 A1
(43) Pub. Date: Apr. 22, 2004

(54) Pellet / pig loading mechanism

(76) Inventor: John H. Nehrbass, Palatine, IL (US)

Correspondence Address: FLUID RECOVERY SYSTEMS, 442 Monterey Road, PALATINE, IL, 60074, US

(21) Appl. No.: 10/271,465

(22) Filed: Oct. 16, 2002

(51) Int. Cl. B08B 9/055

(52) U.S. Cl. 15/104.062; 15/3.5

(57) ABSTRACT

A manual or automatic mechanism designed for the application of loading all types or displacement or cleaning pigs or pellets (here after known as projectiles) of open or closed cell elastomers with or without added cleaning materials as grinding, or scouring particles utilized to transverse all types of geometric tubes, piping, hose or conduit not necessarily round in cross section configuration. The loading mechanism utilizes a three-way diverter ball valve device, but with a straight through passage configured ball as opposed to the normal right angle passage found in a diverter valve. The ball may merely be replaced with a ball from a 2-way ball valve or the right angle path ball may be machined and plugged to provide the straight through passage desired. The loading mechanism may be fabricated in metal or any material required in accord with the specific application. The loading mechanism may be manual loading one projectile at a time, or automatic using an added cartridge attached to the loading port containing multiple projectiles that are fed into the loading device by means of a mechanical spring, or hydraulic or pneumatic pressure. An automatic loader may be fitted with an electrical, hydraulic or pneumatic actuator for feeding and firing the projectiles.

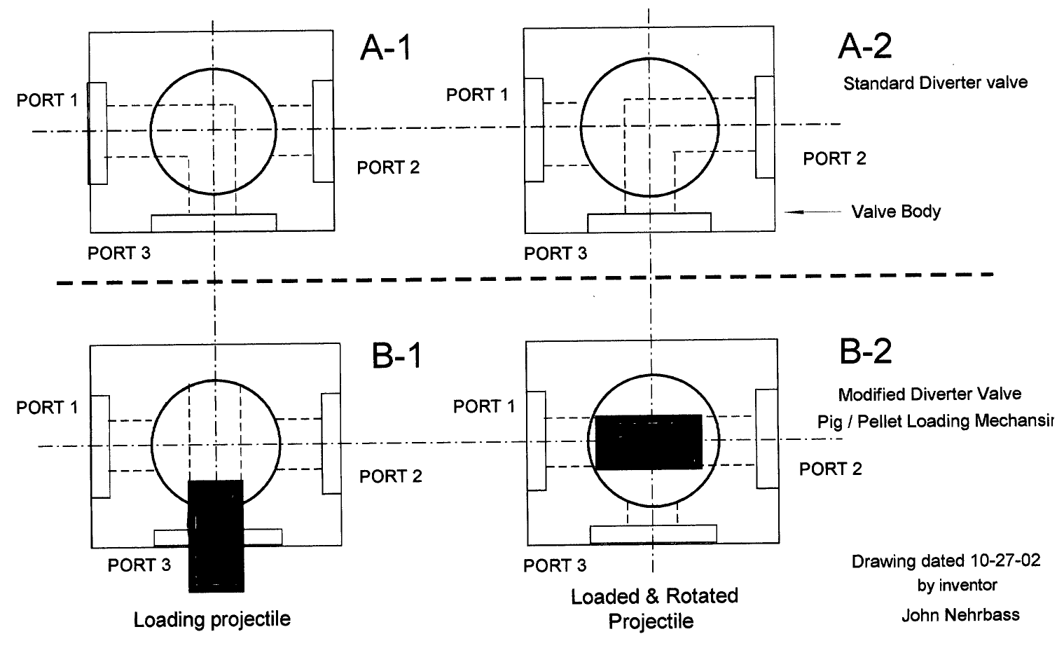

### FIELD OF THE INVENTION

The present invention relates to the field of pipeline, tubing or hose “pigging” or displacement of liquid or gas within the pipeline or cleaning of the pipeline using a projectile as described in the abstract. Pigs or pellets are inserted into the process stream by using a launcher either fixed or portable having an opening for end loading of the projectile and ports for injecting pneumatic or hydraulic pressure to propel the projectile through the pipeline. Other launchers available use an angle or “Y” insertion of the pig as found in the food industry requiring sanitary conditions.

### BACKGROUND OF INVENTION

Pigging launching and pellet gun equipment for the smaller pipe are high in cost in relation to pipe size, as with for example 2-inch diameter and below. By using a separate diverter valve body and modified ball along with an inexpensive lever operated globe valve for introducing and controlling either pneumatic or hydraulic energy to propel the projectile, pipeline displacement and cleaning becomes attractive for the smaller process lines found in industry.

### SUMMARY OF INVENTION

By using a mass produced diverter valve and replacing the 90 degree or right angle path ball with a 180 degree or straight path ball the diverter valve is converted into a projectile loading device without machining the valve body and changing the valve body integrity or working pressure of the valve. On the other hand, the machining or boring of a loading port into the body of a standard 2-way ball valve does affect the integrity of the valve body and negates the working pressure specification stamped on the valve body.

This is a simplistic invention has far reaching affects, as product displacement system costs will be at a level where the use of solvents can be greatly decreased, thus dramatically reducing the process waste-stream. Further, product caught and saved by displacement will have an overall product cost reduction affect. Finally, the low capital cost of a pipeline cleaning system will increase overall product quality. None of these stated benefits are new and are in constant use in larger diameter systems. The invention of a low cost system is aimed at transferring these benefits to the small process pipeline industries.

### BRIEF DESCRIPTION OF DRAWING

Drawings marked A-1 and A-2 illustrate a diverter ball valve showing the paths of flow available with the standard 90-degree right angle passage machined into the ball. Flow is shown diverted between ports 1 & 3 in dwg A-1 and ports 2 & 3 in dwg A-2.

Drawings marked B-1 and B-2 illustrate a diverter ball valve with a 180-degree straight through passage machined into the ball and further showing the loading through port 3 and positioning of the projectile in alignment with ports 1 & 2 connecting the pipeline.

Other variations of the above principles will be apparent to those who are knowledgeable in the field of the invention, and such variations are considered to be within the scope of the present invention. Further, other modifications and alterations may be used in the design and manufacture of the projectile loading mechanism without departing from the spirit and scope of the accompanying claim.

I claim:

1. A projectile loading device used in the application of inner surface displacement or cleaning, separate from the pneumatic or hydraulic powered launching mechanism, utilizing a standard commercially available 3-way diverting ball valve with a modified ball for loading of a projectile into a launch position through the side or “third” port of the diverter valve body and rotated 90 degree into alignment with the pipe or any geometric cross sectional contained space to be displaced or cleaned.
